(19) United States
(12) Patent Application Publication
(10) Pub. No.: US 2008/0177587 A1
(43) Pub. Date: Jul. 24, 2008

(54) PRIORITIZING ORDERS USING BUSINESS FACTORS

(76) Inventors: Sonia Jean Cushing, Rochester, MN (US); Steven C. Erickson, Rochester, MN (US); Kay Marie Momsen, Rochester, MN (US); William Robert Taylor, Rochester, MN (US)

Correspondence Address: DUKE W. YEE;YEE & ASSOCIATES, P.C., P.O. BOX 802333, DALLAS, TX, 75380, US

(21) Appl. No.: 11/625,912

(22) Filed: Jan. 23, 2007

(51) Int. Cl. G06Q 10/00

(52) U.S. Cl. 705/7

(57) ABSTRACT

A computer implemented method, apparatus, and computer program product for prioritizing orders. One or more business factors are prioritized to form prioritized business factors. One or more orders for entities are received. Data about the entities is retrieved. Build sequences for the entities are determined. The build sequences are evaluated using the prioritized business factors to form evaluated business sequences. A business sequence from the evaluated business sequences is selected.

### BACKGROUND OF THE INVENTION

1. Field of the Invention

The present invention relates generally to data processing systems and in particular to data processing systems used for supply chain management. Still more particularly, the present invention relates to a computer implemented method, apparatus, and computer program product for prioritizing manufacturing orders.

2. Description of the Related Art

Most companies report their financial results at the end of a financial reporting period, such as every three months. Most sales people are given sales quotas based on the financial reporting period. Therefore, the end of the financial reporting period generally involves a large number of orders, and these orders may exceed the manufacturing resources available to fulfill the orders before the order's deadline.

Prioritizing a large number of orders using various business factors, including revenue, parts availability, cycle time, capacity, and inventory carrying cost is typically done manually. Manual prioritization of the orders is difficult because of the sheer number of business factors, both for the manufacturer and the customer, to be taken into consideration. For example, for some orders it is acceptable to ship without all the components of the order being filled, while some orders may only ship if all the components of the order are filled.

Manually prioritizing a large number of orders increases the chance of a less than ideal business optimization. Manually prioritizing a large number of orders also requires a significant amount of information regarding parts availability from the manufacturing plant. Therefore, currently, companies do not have a way of optimally prioritizing a large number of orders, such as the orders received at the end of the financial reporting period.

### BRIEF SUMMARY OF THE INVENTION

The different illustrative embodiments provide a computer implemented method, apparatus, and computer program product for prioritizing orders. One or more business factors are prioritized to form prioritized business factors. One or more orders for entities are received. Data about the entities is retrieved. Build sequences for the entities are determined. The build sequences are evaluated using the prioritized business factors to form evaluated business sequences. A business sequence from the evaluated business sequences is selected.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in accordance with an illustrative embodiment;

FIG. 2 is a block diagram of a data processing system in which illustrative embodiments may be implemented;

FIG. 3 is a diagram illustrating a manufacturing optimization in accordance with an illustrative embodiment;

FIG. 4 is a diagram illustrating order requirements in accordance with an illustrative embodiment;

FIG. 5 is a flowchart of a manufacturing optimization in accordance with an illustrative embodiment; and

FIG. 6 is an example of a manufacturing optimization in accordance with an illustrative embodiment.

### DETAILED DESCRIPTION OF THE INVENTION

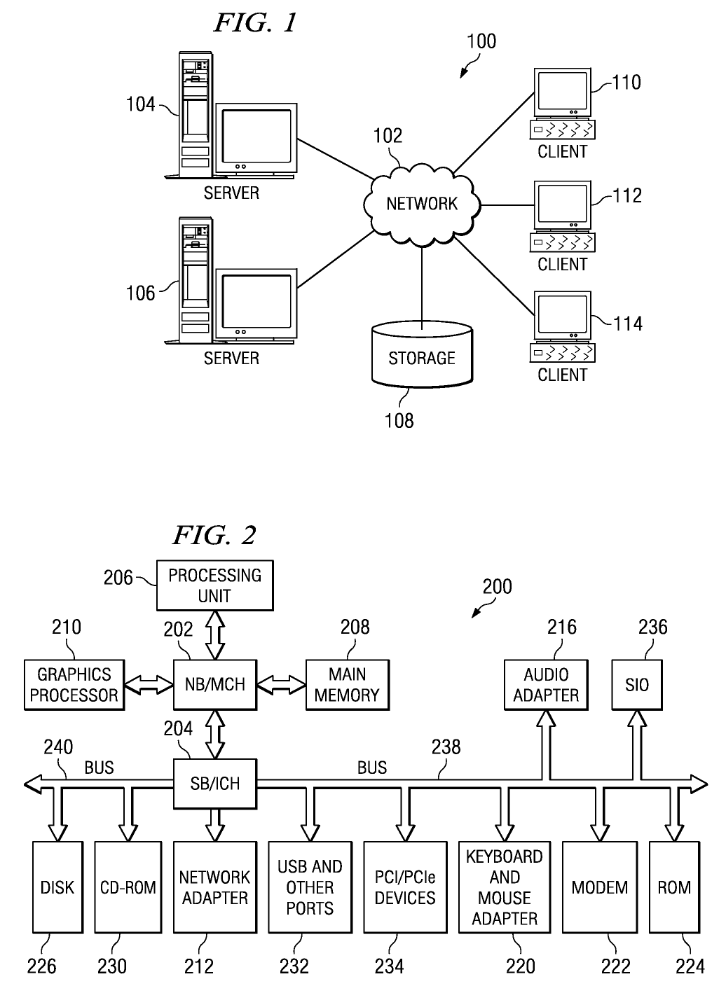

With reference now to the figures and in particular with reference to FIGS. 1 and 2, exemplary diagrams of data processing environments are provided in which illustrative embodiments may be implemented. It should be appreciated that FIGS. 1 and 2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200. Java and all Java-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1 and 2 and above-described examples are not meant to imply architectural limitations. For example, data processing system 200 also may be a tablet computer, laptop computer, or telephone device in addition to taking the form of a PDA.

Most companies report their financial results at the end of a financial reporting period, such as every three months. Most sales come at the end of the financial reporting period because the sales people are given sales quotas for each financial reporting period. Because a company typically receives a large number of orders at the end of the financial reporting period, these orders may exceed the manufacturing resources available to fulfill the orders in a timely manner.

Prioritizing a large number of orders using various business factors, including revenue, parts availability, cycle time, capacity, and inventory carrying cost is usually a manual process. Manual prioritization of a large number of orders is difficult because of the sheer number of business factors to be taken into consideration, both for the manufacturer and the customer. For example, some orders can ship without all the components of the order being filled, while other orders require that the order be shipped only when all the components are available.

Manually prioritizing a large number of orders increases the chance of introducing human error into the prioritization process. Manually prioritizing a large number of orders also requires a significant amount of information regarding parts availability from the manufacturing plant. The embodiments recognize that it would be useful to prioritize a large number of orders taking into account appropriate business factors in order to optimize order fulfillment.

The different illustrative embodiments described herein provide a computer implemented method, apparatus, and computer program product for prioritizing orders. One or more business factors are prioritized to form prioritized business factors. One or more orders for entities are received. Data about the entities is retrieved. Build sequences for the entities are determined. The build sequences are evaluated using the prioritized business factors to form evaluated business sequences. A business sequence from the evaluated business sequences is selected.

An order is a set of requirements from a customer. An order contains a list of one more entities and the corresponding number of entities which the customer wants supplied. An entity may be any manufactured unit, such as a part, a sub-assembly, or completely assembled product. At any given time, a supplier may have one or more orders from one or more customers.

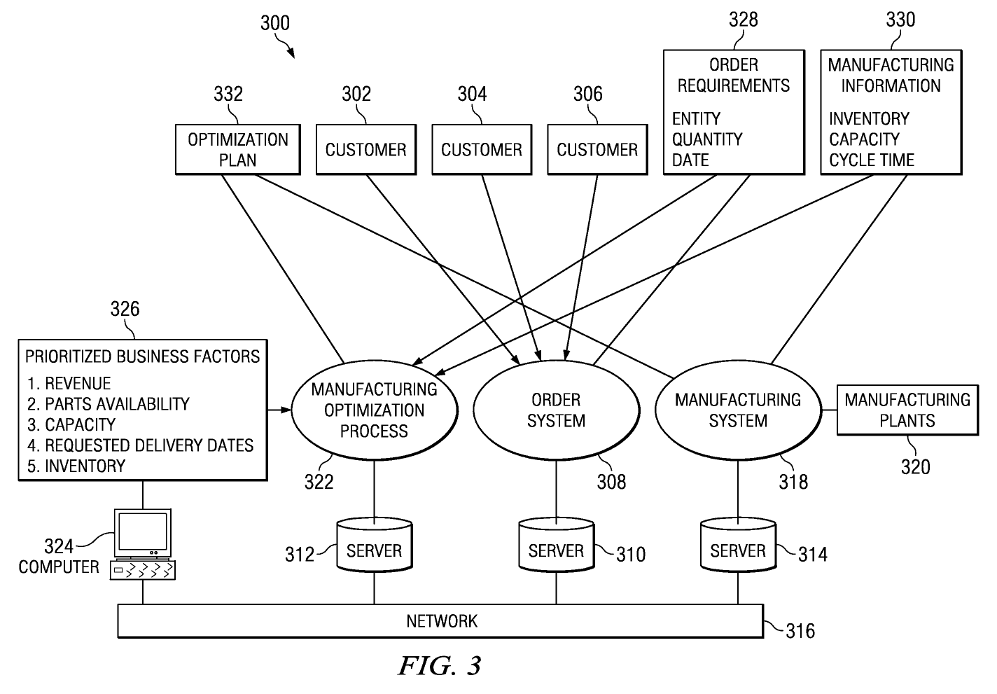

Turning now to FIG. 3, a diagram illustrating a manufacturing optimization is shown in accordance with an illustrative embodiment. In manufacturing optimization 300, customers 302, 304, and 306 each send orders into order system 308. Customers 302, 304, and 306 may submit their orders electronically, or the orders may be sent by paper or over the telephone and the orders may be entered into order system 308 by users.

Order system 308 is a software process which runs on server 310. Server 310, server 312, and server 314 are connected to network 316. Servers 310, 312, and 314 may be the same server or different servers. Manufacturing system 318 is a software process that runs on server 314 and provides information to one or more manufacturing plants 320.

Manufacturing optimization process 322 is a software process that runs on server 312 and optimizes the manufacturing of orders in order system 308. A user on computer 324 creates prioritized business factors 326. A set of prioritized business factors is defined as a set of one or more prioritized business factors. Prioritized business factors 326 is a prioritized list of factors which manufacturing optimization process 322 uses to prioritize the orders in order system 308.

Order system 308 contains order requirements 328. Order requirements 328 contains information about each of the orders received from customers, such as customers 302, 304, and 306. Manufacturing system 318 contains manufacturing information 330. Manufacturing information 330 provides details such as inventory levels, manufacturing capacity for each entity, and how long it takes to manufacture each entity, which is known as cycle time.

Manufacturing optimization process 322 uses prioritized business factors 326, order requirements 328, and manufacturing information 330 to determine optimization plan 332. Optimization plan 332 is a detailed manufacturing plan for manufacturing system 318.

Optimization plan 332 specifies what entities should be manufactured, what quantity of entities should be manufactured, and when the entities should be manufactured. By executing optimization plan 332, customer orders are satisfied in a way which satisfies prioritized business factors 326 and order requirements 328.

Note that order requirements 328 is satisfied to the extent that inventory, manufacturing capacity and cycle time permit, given the order requirements, such as delivery dates and requested quantities.

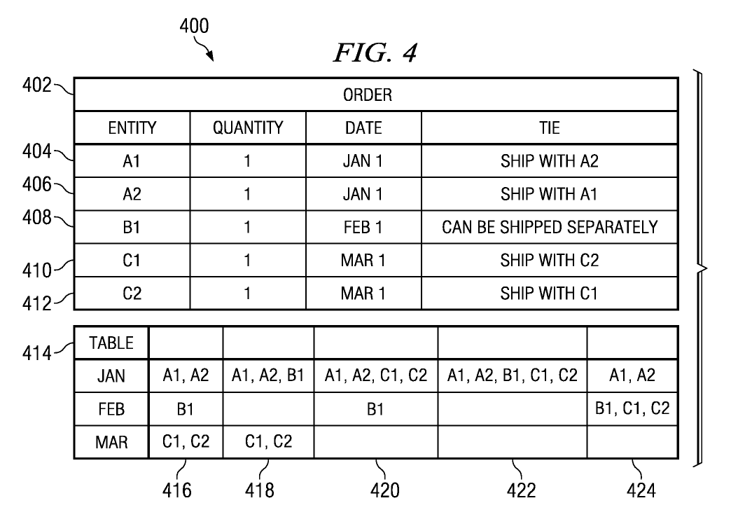

Turning now to FIG. 4, a diagram illustrating order requirements is shown in accordance with an illustrative embodiment. In order requirements 400, order 402 represents an order from a customer, such as customer 302 in FIG. 3.

In this example, order 402 contains the requirements for a customer order, such as the name of each entity being ordered, the quantity for each entity, the date by which the entity should be shipped, and any tie requirements, such as whether one entity must be shipped in the same shipment as another entity. Those versed in the art will appreciate that a customer may specify other requirements in addition to or in place of these requirements. The specific requirements shown in this example are purely for illustration purposes.

Line 404 indicates that one quantity of entity A1 should be shipped by January 1^{st} and that entity A1 should always be shipped with entity A2. Line 406 indicates that one quantity of entity A2 should be shipped by January 1^{st}, and that entity A2 should always be shipped with entity A1. When a customer requests that two or more entities be grouped together for shipment, a “hard tie” between the shipment date for entity A1 and the shipment date for entity A2 is created.

Line 408 indicates that one quantity of entity B1 should be shipped by February 1^{st} and that the shipment of entity B1 need not be tied with the shipment of any other entity. When an entity may be grouped with other entities when the entity is shipped, the entity is said to have a “soft tie”. Lines 410 and 412 indicate that one entity each of C1 and C2 should be shipped together by March 1^{st}.

In this example, an assumption is made that orders shipped ahead of schedule are acceptable to the customer. Table 414 represents the five possible shipping scenarios for order 402, assuming that the customer is willing to accept orders shipped ahead of schedule. For example, column 416 shows that entities A1 and A2 can be shipped on January 1^{st}, entity B1 can be shipped on February 1^{st}, and entities C1 and C2 can be shipped on March 1^{st}.

Similarly, column 418 shows that entities A1, A2, and B1 can be shipped on January 1^{st}, and entities C1 and C2 can be shipped on March 1^{st}. Column 420 shows that entities A1, A2, C1, and C2 can be shipped on January 1^{st} and entity B1 can be shipped on February 1^{st}. Column 422 indicates that entities A1, A2, B1, C1, and C2 can all be shipped on January 1^{st} Column 424 indicates that entities A1 and A2 can be shipped on January 1^{st}, and entities B1, C1, and C2 can be shipped on February 1^{st}.

Taking the business factors which the user has prioritized for this order, the manufacturing optimization process can run through each of the five possible scenarios in columns 416-424 to determine which of the five maximizes the prioritized business factors. For example, if the customer placing the order must make payment within 60 days after an entity is shipped, column 422 is the best scenario to recognize the revenue order in the financial reporting period ending on March 31^{st}. On the other hand, if there are many orders and manufacturing capacity is near peak, column 416 may be the best scenario to maximize manufacturing capacity, taking into account other orders.

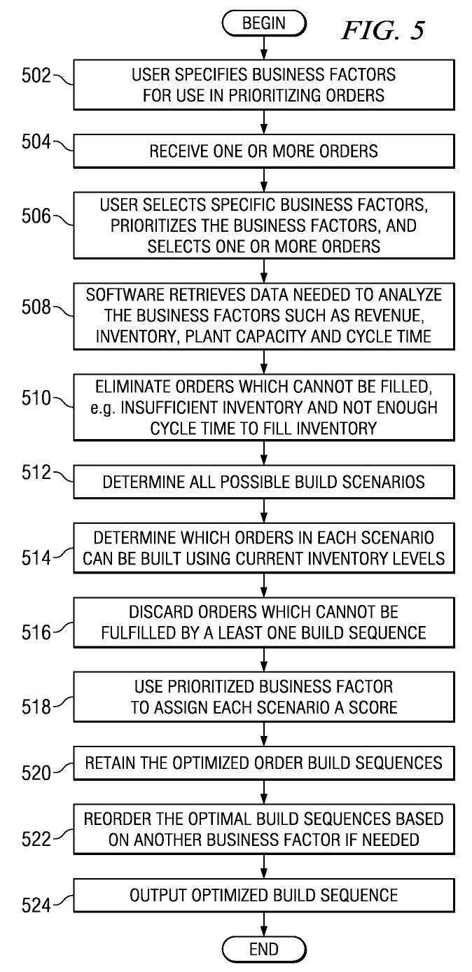

Turning now to FIG. 5, a flowchart of a manufacturing optimization is shown in accordance with an illustrative embodiment. In this example, a flowchart for how a set of orders is optimized for revenue and cycle time is shown. Those versed in the art will appreciate that a similar algorithm may be used for other business factors.

A user specifies one or more business factors (step 502). The supplier's order management software receives one or more orders (step 504). Each order contains order requirements, such as, for example, the name and identification number of each entity, the quantity for each entity, the ship date for each entity, and any hard or soft ties.

The user selects specific business factors, from those defined in step 502, prioritizes the business factors, and selects one or more orders (step 506). The optimization software retrieves the data needed to perform an analysis using the specified business factors (step 508). The type of data retrieved may include revenue, inventory levels, plant capacity, and manufacturing cycle time.

Orders which cannot be fulfilled are eliminated (step 510). For example, an order may be eliminated if there is insufficient inventory for the specified entity, or the time remaining to build is less than the manufacturing cycle time. For the remaining orders, all possible build sequences are determined (step 512). Each build sequence is examined and a determination is made as to whether the orders can be satisfied using current inventory levels (step 514). Step 514 may be performed in such a way that each build sequence is evaluated substantially in parallel with the other build sequences. Orders which cannot be fulfilled by at least one build sequence are discarded (step 516).

Each remaining build sequence is examined and assigned a score based on the prioritized business factors (step 518). After this step, the optimization process has a list of build sequences which can be completed using existing inventory levels and a score assigned to each build sequence based on the prioritized business factors. For example, the score may indicate the amount of revenue each build sequence will generate.

After examining each build sequence and assigning a score based on the prioritized business factors, the most optimized build sequence(s) are chosen based on the score (step 520). In this example, the optimized build sequence chosen is the build sequence which generates the most revenue. The build sequence is then optionally reordered using any additional business factor (step 522).

For example, assume several build sequences generate the same maximum revenue. Assume also that the orders represent orders from four different customers, and one of those customers is a new customer or a customer that requires preferential treatment. The build sequences can be re-ordered based on the customer, so that the build sequence which fulfills all the orders for one particular customer is bumped to the top. Finally, the optimized build sequence is output to manufacturing (step 524) and the process ends.

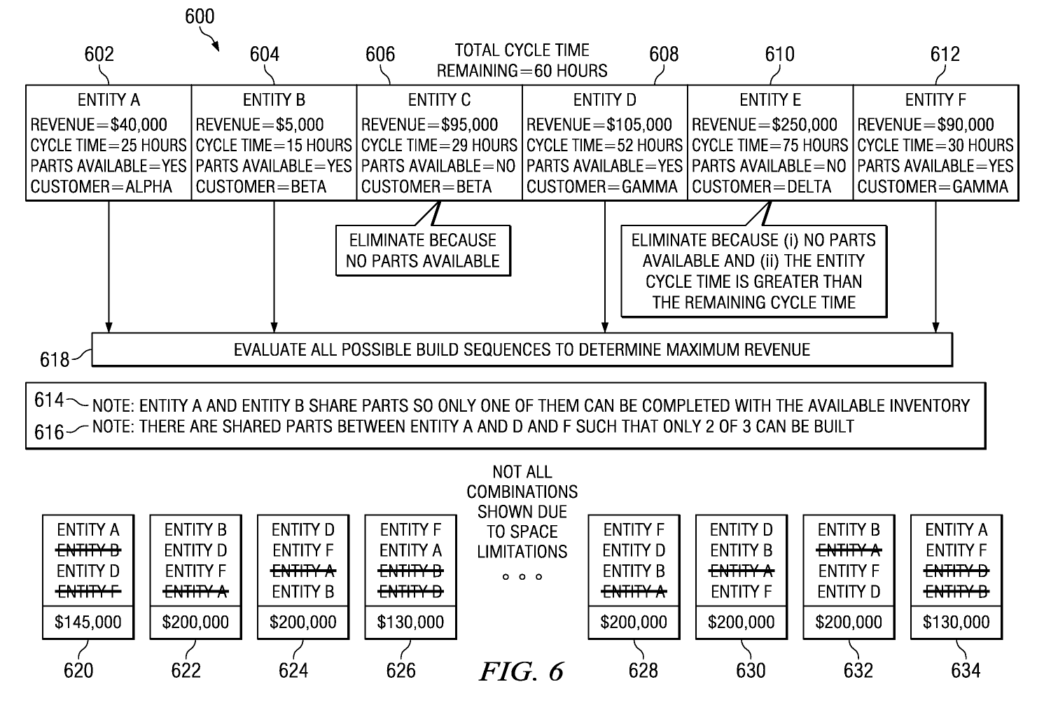

Turning now to FIG. 6, an example of a manufacturing optimization is shown in accordance with an illustrative embodiment. In manufacturing optimization 600, an assumption is made that the total remaining manufacturing cycle time available is 60 hours.

In this example, orders from customers alpha, beta, delta, and gamma for entities A, B, C, D, E, and F are received. Revenue is selected as the business factor to use when optimizing the orders. Data 602-612 represents the data retrieved from the ordering, manufacturing, and inventory systems. The order for entity C is eliminated because there are not enough parts in inventory to satisfy the demand for entity C. The order for entity E is eliminated because entity E requires seventy-five hours of cycle time but only sixty hours of cycle time remain.

Notes 614 and 616 represent two additional pieces of information that were obtained from the manufacturing system. Note 614 specifies that entity A and entity B share parts and so only one of these entities may be completed using the available inventory. Note 616 specifies that three entities, A, D and F, share parts and so only two of the entities may be built. The information from notes 614 and 616 is used in step 618 to evaluate all possible build sequences to determine the maximum revenue possible.

Build sequences 620-634 represent a subset of all build sequences that are possible in this example. For example, in build sequence 620, $145,000 of revenue is generated when entity A and entity D are built. Note that entity B and entity F have been crossed off of build sequence 620 because of notes 614 and 616.

In this example, $200,000 is the maximum revenue that a build sequence can generate. Optionally, if there is more than one build sequence that generates the maximum revenue, another business factor may be used to select among those build sequences. In this example, build sequences 622, 624, 628, 630 and 632 all generate $200,000 revenue, which is the maximum possible revenue for this set of orders. One of these build sequences may be chosen based on another factor, such as cycle times or customer priority. For example, suppose customer gamma is to be given preferential treatment because customer gamma is a new customer. Build sequence 624 could be chosen because the orders which customer gamma has placed are filled first.

The different illustrative embodiments described herein provide a computer implemented method, apparatus, and computer program product for prioritizing orders. One or more business factors are prioritized to form prioritized business factors. One or more orders for entities are received. Data about the entities is retrieved. Build sequences for the entities are determined. The build sequences are evaluated using the prioritized business factors to form evaluated business sequences. A business sequence from the evaluated business sequences is selected.

The different embodiments maximize the business output for a set of orders using one or more business factors. A user initially defines and prioritizes one or more business factors. The embodiments account for multiple entities within one order and whether or not a partial shipment is acceptable. The embodiments prioritize order fulfillment to take into account user defined business factors, such as revenue generated by each order, parts availability, manufacturing cycle times, capacity, and requested delivery dates.

First, the user defines one or more business factors to take into account when optimizing the set of orders. Second, the user selects a subset of the business factors. Third, the user prioritizes the business factors. For example, the user may specify that maximizing revenue is of primary importance, and for orders with the same revenue, maximizing the usage of available inventory is of secondary importance. Fourth, the user selects a set of orders and applies the prioritized business factors. Finally, the embodiments prioritize the set of orders using the supplied business factors and output a prioritized list of orders. The prioritized list of orders is typically sent directly to the manufacturing systems of the supplier.

The different embodiments provide a computer implemented method, apparatus, and computer program product for prioritizing orders. One or more business factors are defined. The one or more business factors are prioritized to form prioritized business factors. One or more orders for entities are received. Data about the entities is retrieved. Build sequences for the entities are determined. The build sequences are evaluated using the prioritized business factors to form evaluated business sequences. A business sequence from the evaluated business sequences is selected.

An order is defined as a total customer solution to be shipped together from a plant. One order may include multiple entities. The embodiments may obtain the necessary data from multiple systems and then compile, manipulate, and analyze that data based on the business factors defined. The embodiments use delivery document rules and production order rules to determine whether a partial shipment is acceptable. Each possible build sequence may be analyzed to determine which build sequence provides the most optimal output.

Software is used to prioritize the manufacturing process for multiple orders in real-time using user defined business factors. Critical business factors could include, but are not limited to, revenue, inventory utilization, and capacity utilization. The software may be run on a regular basis as a planning tool for prioritization or directly tied into the manufacturing systems to drive manufacturing.

The different embodiments provide several advantages over conventional systems. First, human errors that result in less than optimal business output may be eliminated. Second, a real-time snapshot of order load may be used to automatically prioritize orders without manual intervention. Third, multiple entities within an order can be analyzed and optimized.

The flowcharts and block diagrams in the different depicted embodiments illustrate the architecture, functionality, and operation of some possible implementations of apparatus, methods, and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

The description of the illustrative embodiments has been presented for purposes of illustration and description and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for prioritizing orders; the computer implemented method comprising:
prioritizing one or more business factors to form a set of prioritized business factors;
receiving one or more orders for entities;
retrieving data about the entities;
determining build sequences for the entities;
evaluating the build sequences based on the set of prioritized business factors to form evaluated business sequences; and
selecting a business sequence from the evaluated business sequences.

2. The computer implemented method of claim 1 further comprising:
defining the one or more business factors.

3. The computer implemented method of claim 1, wherein the one or more business factors are at least one of revenue, parts availability, plant capacity, customer priority, and cycle time.

4. The computer implemented method of claim 2 wherein the step of defining the one or more business factors further comprises:
selecting, by a user, the one or more business factors to form the set of prioritized business factors.

5. The computer implemented method of claim 1 wherein the step of prioritizing the one or more business factors further comprises:
assigning a priority to each business factor in the set of prioritized business factors by a user.

6. The computer implemented method of claim 1, wherein the step of selecting the business sequence from the evaluated business sequences further comprises:
selecting the business sequence which maximizes at least one of the prioritized business factors.

7. The computer implemented method of claim 1, further comprising:
selecting one or more business sequences from the evaluated business sequences to form prioritized business sequences, wherein the prioritized business sequences maximize the set of prioritized business factors; and
selecting a prioritized business sequence from the prioritized business sequences using a business factor.

8. A computer program product comprising a computer usable medium including computer usable program code for prioritizing orders, the computer program product comprising:
computer usable code for prioritizing one or more business factors to form a set of prioritized business factors;
computer usable code for receiving one or more orders for entities;
computer usable code for retrieving data about the entities;
computer usable code for determining build sequences for the entities;
computer usable code for evaluating the build sequences based on the set of prioritized business factors to form evaluated business sequences; and
computer usable code for selecting a business sequence from the evaluated business sequences.

9. The computer program product of claim 8 further comprising:
computer usable code for defining the one or more business factors.

10. The computer program product of claim 8, wherein the one or more business factors are at least one of revenue, parts availability, plant capacity, customer priority, and cycle time.

11. The computer program product of claim 9 wherein defining the one or more business factors further comprises:
computer usable code for selecting, by a user, the one or more business factors to form the set of prioritized business factors.

12. The computer program product of claim 8 wherein prioritizing the one or more business factors further comprises:
computer usable code for assigning a priority to each business factor in the set of prioritized business factors by a user.

13. The computer program product of claim 8, wherein the computer usable code for selecting the business sequence from the evaluated business sequences further comprises:
computer usable code for selecting the business sequence which maximizes at least one of the prioritized business factors.

14. The computer program product of claim 8, further comprising:
computer usable code for selecting one or more business sequences from the evaluated business sequences to form prioritized business sequences, wherein the prioritized business sequences maximize the set of prioritized business factors; and
computer usable code for selecting a prioritized business sequence from the prioritized business sequences using a business factor.

15. A data processing system for prioritizing orders, the data processing system comprising:
prioritizing means for prioritizing one or more business factors to form a set of prioritized business factors;
receiving means for receiving one or more orders for entities;
retrieving means for retrieving data about the entities;
determining means for determining build sequences for the entities;
evaluating means for evaluating the build sequences based on the set of prioritized business factors to form evaluated business sequences; and
selection means for selecting a business sequence from the evaluated business sequences.

16. The data processing system of claim 15, wherein the one or more business factors are at least one of revenue, parts availability, plant capacity, customer priority, and cycle time.

17. The data processing system of claim 16, wherein the one or more business factors are defined by a user selecting the one or more business factors to form the set of prioritized business factors.

18. The data processing system of claim 17, further comprising:
prioritizing means for prioritizing the one or more business factors by further executing computer usable code to assign a priority to each business factor in the set of prioritized business factors.

19. The data processing system of claim 15 wherein the selecting means for selecting the business sequence from the evaluated business sequences selects the business sequence which maximizes at least one of the prioritized business factors.

20. The data processing system of claim 15, further comprising:
selection means for selecting one or more business sequences from the evaluated business sequences to form prioritized business sequences, wherein the prioritized business sequences maximize the set of prioritized business factors; and
selection means for selecting a prioritized business sequence from the prioritized business sequences using a business factor.
